(19) United States
(12) Patent Application Publication
(10) Pub. No.: US 2007/0268698 A1
(43) Pub. Date: Nov. 22, 2007

(54) LED illuminating device

(75) Inventors: Wei-Rur Chen, Sindian City (TW); Szu-Tang Chen, Sindian City (TW); Chi-Feng Yu, Sindian City (TW)

Correspondence Address: BACON & THOMAS, PLLC, 625 SLATERS LANE, FOURTH FLOOR, ALEXANDRIA, VA, 22314, US

(73) Assignee: Color Stars, Inc., Sindian City (TW)

(21) Appl. No.: 11/435,868

(22) Filed: May 18, 2006

(51) Int. Cl. F21V 21/32

(52) U.S. Cl. 362/250

(57) ABSTRACT

A LED illuminating device with rotating capability for showcases or the like is disclosed in the present invention comprising an enclosure with a rectangular shape in front view and side covers attached to both ends of the enclosure. A substrate is attached within the enclosure and a plurality of light emitting diode (LED) is formed on and along the substrate. A transparent front cover is attached to the front side of the enclosure and a rotator is connected to the enclosure to allow the enclosure being rotated via an axis to a desired angle.

### FIELD OF THE INVENTION

The present invention relates generally to light emitting diode (LED) illuminating devices, and more particularly to a LED illuminating device with rotating capability for showcases or the like.

### BACKGROUND OF THE INVENTION

Light emitting diodes (LEDs) have become a significant illumination technology with a wide variety of applications in the past few decades. Since their initial invention, LEDs have been utilized in numerous diverse applications such as watches, calculators, remote controls, cell phones, indicator lights and backlights for many common gadgets and household devices. The technology is advancing at a rapid pace, and new applications continue to emerge as the LEDs brightness and efficiency increase.

Compared with the traditional incandescent light bulbs or fluorescence sources, LEDs offer a huge variety of benefits. First of all, they are much more robust mechanically because LED lighting systems are inherently resistant to vibration problems and can be designed to withstand almost any extreme environment more easily than traditional lighting. And there is no glass and filament to break or burn out. Second, LEDs typically last about 30 times longer than incandescent lamps of similar size and brightness, and on average 4 times longer than a common fluorescent. Moreover, while a burned out lamp can have a damaging impact on aesthetics, the gradual dimming that will occur beyond the useful life of an LED-based system will not have the dramatic negative effect and will not require immediate maintenance.

Third, LEDs are very energy efficient and typically require only 10 to 20% of the power required by incandescent lamps of similar brightness. LEDs have the potential to achieve more than 90% conversion efficiencies as a light source compared to under 50% for conventional sources. A common house light bulb is approximately 9% efficient. Because they are able to convert electricity directly into light, for the first time in history, LEDs offer the promise of producing more light than heat from the energy supplied. Consequently, this has enormous implications for energy savings on a global scale in the future.

Furthermore, the size of an LED is very small and the light rays it produces are emitted in a very narrow beam. This implies that optical systems can be designed to control the light with extremely high efficiency, resulting in less light being required to perform a certain function, which in turn increases the energy efficiency of the system. Also, as the world goes digital, it becomes increasingly important that lighting become integrated into that world. Solid state lighting (SSL) LED is already a digital system that can be interfaced with other systems or precisely controlled to achieve maximum performance. For instance, it is possible to program an RGB array to produce almost any color and because light is not being filtered or absorbed, the result is a deeper saturation of the color. This also applies to individual LED colors such as red which is produced directly and not by filtering out all of the blue, green, and yellow present in the light source. Finally, current LED lighting systems generally operate on low voltage DC power, making them very safe to install and operate. However, as LED is a semiconductor, each LED chip has its own electronic characteristics. The forward voltage for triggering current flow through the LED chip may vary from LED to LED. It is important to apply constant current flow through the LED, and not the constant voltage to ensure that all of the LEDs in line have the same light emitting level.

Recent innovations in the LED manufacturing of the die material and packaging have resulted in ultra high brightness capabilities. The use of new materials for the substrate have allowed for improved thermal conductivity which in turn create higher power consumption and net light output. This increase in light output has enabled new applications for LEDs such as automotive lighting, traffic signals, and more recently, television displays.

Controlling the thermal stability of the LED die is critical to the performance and stability of LED illumination and reliability. The LED architecture inherently produces light from all sides and surfaces of the PN structure in a lambertian distribution (uniform distribution into a 180 degree hemisphere). While this might seem efficient, most of this light is actually absorbed into adjacent die, the mounting substrate, or other surfaces of the LED assembly. This absorption results in an increased thermal loading of the entire LED assembly. This heat must be addressed to obtain maximum light output and reliability.

As indicated above, LEDs are promising for general lighting in the near future. However, the issues of optics, thermal management, and constant current driver must all be addressed and integrated into the product design to ensure the reliability and performance. Moreover, by jointing multiple LED spot light sources linearly will provide evenly distributed illumination for any linear zones or spaces. Also considering the most effective adoption to LED lighting is to retrofit the existing traditional lamps. Accordingly, what is desirable is a new linear LED illuminating device with multiple LEDs mounting on a metal cored plastic circuit board (MCPCB) and with a 2-prong MR16 type plug that can plug into the existing MR16 socket. It is also desirable for the new linear LED illuminating device to possess heat dissipation capability with rotating capability for the adjustment of light projection direction. The linear matrix or arrays of multiple LEDs can be of any single color, e.g. red, blue, green, white, warm white, or any other color providing mono-color lighting. Also, the combinations of any colors can be installed in LEDs for color mixing, especially red, blue, and green which can be mixed to create various colors in the rainbow spectrum.

### SUMMARY OF THE INVENTION

In the light of the drawbacks in the prior art as discussed above, the present invention proposes a linear LED illuminating device with a rotator between the plug and the linear housing which enables variable light projection direction for illumination application in wall hanging objects, showcases, display shelves, furniture, kitchenware, and so on. The proposed linear LED illuminating device can include a 2-prong MR16 type of plug for low-voltage power input and a built-in constant current driver within the plug structure. The new linear LED illuminating device has the following advantages over conventional lamp bulbs or LED lamps.

One advantage of the present invention is that the proposed LED illuminating device with the rotator is highly versatile such that it is able to plug into any MR16 type socket for the retrofit of any traditional MR16 lamps and to rotate around to various angles to light up different directions, a unique design characteristic that far exceeds the possibilities of traditional illumination sources and conventional LED lamps.

Another advantage of the present invention is that the proposed LED illuminating device may vary in a wide range of shapes and sizes to accommodate different aesthetics and taste requirements while maintaining the heat management function. The cross-section of the linear housing can be configured in the shape of, for example, including but not limited to rectangle, square, circle, semicircle, curve, triangle, trapezoid or any kind of suitable shapes.

Still another advantage of the present invention over conventional light bulbs is that the proposed LED illuminating device is considerably energy saving. The presented LED illuminating device has low power consumption which needs only 1 W˜12 W, whereas conventional illumination devices typically requires higher power such as 100 W for lighting. Its built-in constant current driver within the plug structure ensures even lighting intensity of each LED in the array.

Yet another advantage of the present invention is that the proposed LED illuminating device with the fin-like structure on the top and bottom surfaces of the enclosure possesses good heat dissipation capability relative to conventional illumination devices.

A LED illuminating device with rotating capability for showcases or the like is disclosed in the present invention comprising an enclosure with a rectangular shape in front view and side covers attached to both ends of the enclosure. A substrate is attached within the enclosure and a plurality of light emitting diode (LED) is formed on and along the substrate. A transparent front cover is attached to the front side of the enclosure and a rotator is connected to the enclosure to allow the enclosure being rotated via an axis to a desired angle.

The enclosure, side cover or the substrate are made of aluminum, copper or the combination thereof. The enclosure further includes fin-like architectures formed thereon to improve the thermal dissipation capability. The fin-like architectures are configured in a strip type. The cross-section shape of the enclosure includes rectangular, square, semicircular, circular, curved, triangular or trapezoid. The material of the transparent front cover includes glass, quartz, plastic or acrylic. A socket model fit for the illuminating device includes the model named as MR16, MR11, and GU10, or any other sockets with 2 holes.

The aforementioned objects, features, and advantages will become apparent from the following detailed description of a preferred embodiment taken together with the accompanying drawings.

### BRIEF DESCRIPTION OF THE DRAWINGS

A preferred embodiment of the invention will be illustrated further in the following description and accompanying drawings, and wherein:

FIG. 1 is a mechanical explosion drawing of the LED illuminating device according to the present invention.

FIG. 2A is a 3D structural diagram of the LED illuminating device according to the present invention.

FIG. 2B is a perspective front view of the LED illuminating device according to the present invention.

FIG. 3A is a top view of the LED illuminating device according to the present invention.

FIG. 3B is a cross-sectional schematic diagram of A-A′ line taken from FIG. 3A.

FIG. 4 is a block diagram of the driving circuit for illumination according to the present invention.

### DETAILED DESCRIPTION OF A PREFERRED EMBODIMENT

A light emitting diode (LED) illuminating device with rotating capability for showcases or the like is disclosed in the present invention. The embodiments of the invention will now be described in detailed below with reference to the accompanying drawings, and the preferred embodiment is for illustration only and not for the purpose of limiting the invention.

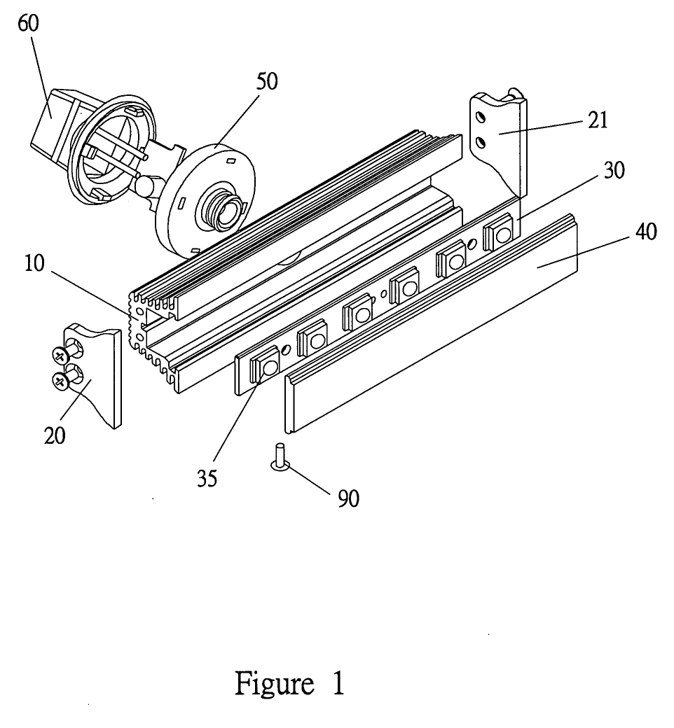

Referring to FIG. 1, there is provided a mechanical explosion drawing of the LED illuminating device according to the present invention. The LED illuminating device comprises an enclosure 10, and preferably, it is made of aluminum (Al), copper (Cu) or the combination thereof. Side covers 20 and 21 attached to both ends of the housing are employed to enclose the die. The present invention further includes a substrate 30, a transparent front cover 40 and a rotator 50. It is understood, however, the cross-section of the enclosure 10 can be in various form to suit one's particular need or for aesthetic attractiveness. To list a few, for example, the cross-section shape of the enclosure 10 includes but not limited to rectangular, square, semicircular, circular, curved, triangular, trapezoid or any kind of suitable shapes. As shown in FIG. 1, the cross-section of the enclosure 10 of the LED illuminating device is, for instance, in trapezoid-like shape in the present invention.

Similarly, the size of the enclosure 10 of the LED illuminating device according to the present invention includes various dimensions to suit specific individual needs. It shall be appreciated that the specific embodiment above of the invention has been described herein for purposes of illustration rather than limiting the invention.

The substrate 30 is placed inside the enclosure 10 and the material for the substrate 30 is preferably aluminum or copper. At least one illuminating elements 35 can be disposed on the surface of the substrate 30 to provide various degrees of brightness. One candidate of the illuminating elements 35 is LED. Preferably, a plurality of LED is arranged with a linear configuration. The material for the enclosure 10, the side covers 20, 21 and the substrate 30 include aluminum or copper due to the material has better thermal dissipation. In one embodiment, Al is preferably employed since substances made of Cu are relatively heavy. The transparent front cover 40 engages with the front side of the housing and the transparent front cover 40 with the side covers 20, 21 offer protection for the illuminating elements 35 inside the enclosure 10. The see-through nature of the transparent front cover 40 allows light emitting from the illuminating elements 35 to pass through. The transparent front cover 40 can be a lens for optical purpose (such as focusing) or simply transparent acryl. In other embodiments, the transparent front cover 40 can be a reflector to reflect the illumination illuminated by the LED. The material for the transparent front cover 40 can be selected from glass, quartz, plastic, acrylic or the like. Alternatively, the front cover can be made as frosted or semi-transparent material.

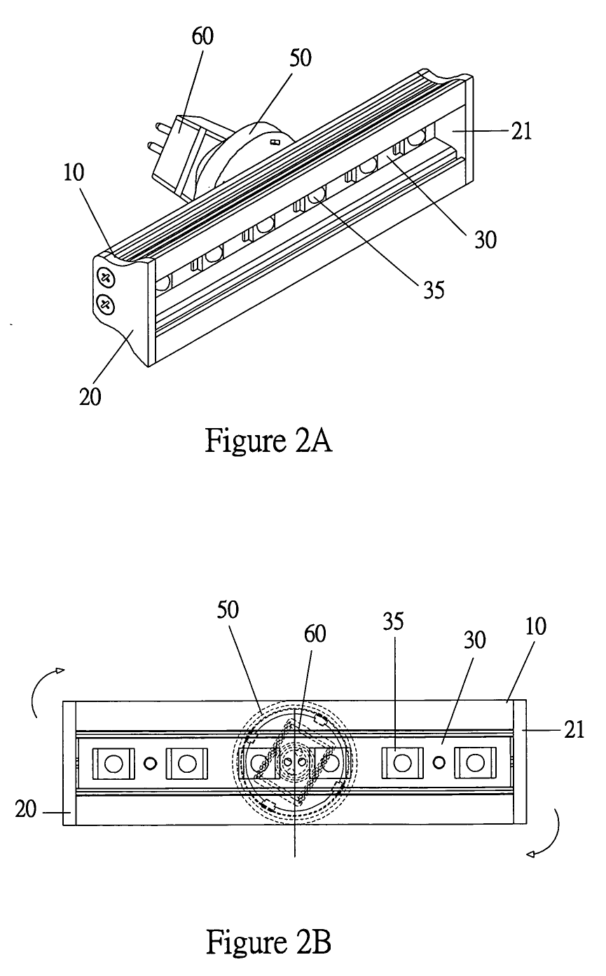

The rotator 50 is attached to the substantial center of the back side of the enclosure 10 which enables the whole linear housing structure to rotate around to any angle based on specific individual needs. The particular emphasis of the present invention is upon the rotator 50 since this very component offers benefits which conventional illuminating devices were unable to accomplish. The material used for the rotator 50 includes ABS (acrylonitrile-butadiene-styrene), Al or Al—Mg alloy. A screw 90 is provided to fix the LED illuminating device in the final assembly form. The rotator 50 along with the whole linear housing structure is now in complete assembly and can be mounted in a socket 60 for lighting, as shown in FIG. 2A illustrating the final assembly of the LED illuminating device of the present invention. The types of the socket 60 mentioned above include MR16, MR11 and GU10 with MR16 used most commonly.

FIG. 2B is a perspective front view of the LED illuminating device according to the present invention. The dotted lines in the center of the rectangular structure indicate the rotator 50 and the socket 60 that are attached to the back of the enclosure 10, and the two arrows on the top left and bottom right corners signify that the whole linear housing structure can be rotated around. The driving circuits (not shown) for illumination can be set within the rotator 50.

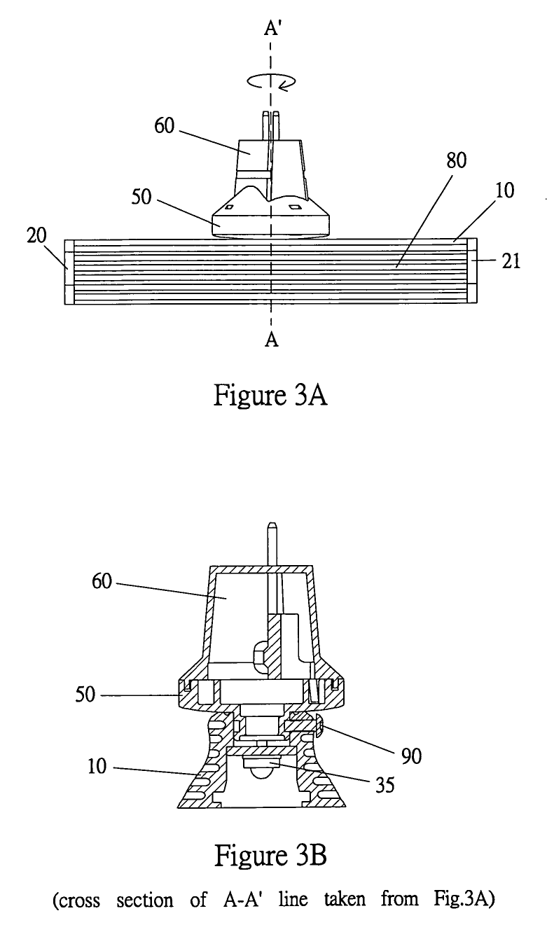

FIG. 3A is a top view of the LED illuminating device according to the present invention. Besides the rotating capability of the LED illuminating device mentioned above, the fin-like architecture 80 on the top and bottom surfaces of the enclosure 10 further promotes the value of the present invention by facilitating heat dissipation through increasing the surface area of the enclosure 10. The cross-section of the A-A′ line in FIG. 3A will be shown in FIG. 3B. In addition, the A-A′ line can be used as an axis of rotation for the whole linear housing structure. FIG. 3B is a cross-sectional schematic diagram of the A-A′ line taken from FIG. 3A. After the whole housing structure is rotated to a desired angle, a fixing means such as the screw 90 can then be used to fix the position of the LED illuminating device in the set angle.

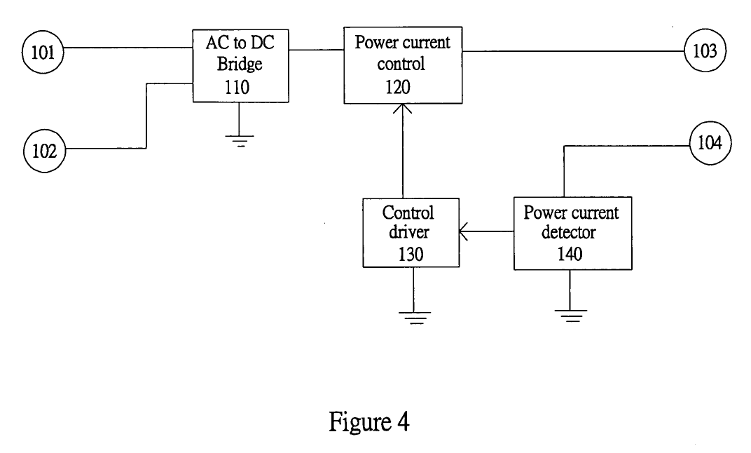

FIG. 4 is a block diagram of the driving circuit for illumination according to the present invention. It provides 12V power to LED according to the present invention. It is important to note that the LED luminous intensity and chromaticity (color) are best controlled by driving it with constant current. In general, LED brightness is proportional to the current flowing through it. Since current in most LED driving schemes is a function of the voltage applied, power supplies have a major impact on the appearance of LED brightness. Thus, any variation between the power supply output voltages has the potential to impact the relative brightness of the LEDs.

The numeric 101 is AC/DC power input, the numeric 102 indicates 12V AC/DC+/−20%, the numeric 103 is LED power output and the numeric 104 represents the parameters of the power (for provided LED 3.2˜10.6 V DC and 20˜700 mA power). The block 110 is AC to DC bridge which is connected to the block 120 power current control. The AC to DC bridge converts AC to DC for LED current supply. The block 130 is a control driver, and the block 140 is a power current detector which detection range falls within 20 mA to 700 mA. The AC to DC bridge 110, the control driver 130, and the power current detector 140 are all grounded.

In conclusion, the proposed LED illuminating device with rotating capability for showcases or the like in the present invention has the following advantages over conventional illuminating devices. One advantage is that the proposed LED illuminating device is exceptionally versatile such that it is able to rotate around to any angle based on specific individual needs when mounted in a socket, which is a unique design characteristic that far exceeds the possibilities of traditional illumination sources and conventional LEDs. Another advantage of the proposed LED illuminating device is that it may vary in a wide range of shapes and sizes to meet almost any requirements. For example, the cross-section of the enclosure can be configured in the shape of, including but not limited to rectangle, square, circle, semicircle, curve, triangle, trapezoid or any kind of suitable shapes.

Still another advantage of the proposed LED illuminating device is that it is considerably energy efficient. The presented LED illuminating device has low power consumption which requires only 1 W ˜12 W, whereas conventional illumination devices typically requires higher power such as 100 W for lighting. Yet another advantage of the proposed LED illuminating device is that compared with conventional illumination devices, it possesses better heat dissipation capability due to the fin-like architecture on the top and bottom surfaces of the enclosure.

From the foregoing, it shall be appreciated that specific embodiments of the invention have been described herein for purposes of illustration, but that various modifications and alterations may be made by those skilled in the art without deviating from the spirit and scope of the invention. For example, it shall be understood that there is no intention to limit the shape and size of the enclosure 10 disclosed above, but on the contrary, the invention is to cover all modifications, alternate constructions and equivalents falling within the spirit and scope of the invention. Accordingly, the invention is not limited except as by the appended claims.

We claim:

1. A light emitting diode (LED) illuminating device comprising:
an enclosure with a rectangular shape in front view;
side covers attached to both ends of said enclosure;
a substrate attached within said enclosure;
a plurality of light emitting diode (LED) formed on and along said substrate;
a transparent front cover attached to the front side of said enclosure; and
a rotator connected to said enclosure to allow said enclosure being rotated via an axis to a desired angle.

2. The LED illuminating device of claim 1, wherein said enclosure is made of aluminum, copper or the combination thereof.

3. The LED illuminating device of claim 1, wherein said side covers are made of aluminum, copper or the combination thereof.

4. The LED illuminating device of claim 1, wherein said substrate is made of aluminum, copper or the combination thereof.

5. The LED illuminating device of claim 1, wherein said enclosure includes fin-like architecture formed thereon to improve the thermal dissipation capability.

6. The LED illuminating device of claim 1, wherein the cross-section shape of said enclosure includes rectangular, square, semicircular, circular, curved, triangular or trapezoid.

7. The LED illuminating device of claim 1, wherein said transparent front cover includes a lens.

8. The LED illuminating device of claim 1, wherein said transparent front cover includes a reflector.

9. The LED illuminating device of claim 1, wherein the material of said transparent front cover includes glass, quartz, plastic or acrylic.

10. The LED illuminating device of claim 1, wherein said transparent front cover can be made as frosted or semi-transparent.

11. The LED illuminating device of claim 1, wherein a socket model fit for said LED illuminating device includes MR16, MR11 and GU10.

12. The LED illuminating device of claim 11, wherein said socket is a two-hole socket.

13. The LED illuminating device of claim 1, wherein said LED illuminating device includes a 2-prong MR16 type of plug.

14. The LED illuminating device of claim 1, further comprising a fixing means to fix said rotator.

15. The LED illuminating device of claim 1, wherein said plurality of LED is arranged with a linear configuration.
